(19) United States
(12) Patent Application Publication
(10) Pub. No.: US 2022/0227450 A1
(43) Pub. Date: Jul. 21, 2022

(54) Actuator device for a hydraulic brake/clutch actuation system of a motorcycle

(71) Applicant: Vity's Design di Vitali Matteo, Fermo (FM) (IT)

(72) Inventor: Massimo IACOPINI, Fermo (FM) (IT)

(21) Appl. No.: 17/580,366

(22) Filed: Jan. 20, 2022

(30) Foreign Application Priority Data
Jan. 20, 2021 (IT) 102021000000944

(51) Int. Cl. B62L 3/02

(52) U.S. Cl. CPC B62L 3/023

(57) ABSTRACT

The present invention relates to an actuator device (1) for a hydraulic brake/clutch actuation system of a motorcycle, comprising a secondary support structure (21) provided with at least a secondary chamber (211), a secondary piston (22) arranged within the secondary support structure (21) and able to be moved within the secondary chamber (211) between a secondary resting position and a secondary working position, and vice versa, a secondary actuating pin (23) solidly coupled to the secondary piston (22) and arranged outside the secondary support structure (21), wherein the free end (231) of the secondary actuating pin (23) is distanced from the secondary support structure (21) when the secondary piston (22) is in the secondary working position and is arranged at the secondary support structure (21) when the secondary piston (22) is in the secondary resting position, a secondary elastic element (24) arranged within the secondary support structure (21) and able to maintain the secondary piston (22) in the secondary working position when not actuated, wherein the primary chamber (111) and the secondary chamber (211) are arranged in fluid communication so that the secondary piston (22) is arranged from the secondary working position to the secondary resting position by the movement of a hydraulic fluid when the primary piston (12) is actuated from the primary resting position to the primary working position, and wherein the secondary elastic element (24) is arranged within the secondary chamber (211).

### FIELD OF INVENTION

The present invention relates to the field of hydraulic brake/clutch actuation systems of motorcycles.

The present invention relates, in particular, to an actuator device for the hydraulic brake/clutch actuation system of a motorcycle, operating an electric push-button panel.

### BACKGROUND ART

Hydraulic brake or clutch actuation systems are increasingly used in motorcycles. These hydraulic systems are equipped with an actuator device which, on command of the user, activates the brake or clutch respectively. The actuation is, therefore, of the hydraulic type and involves the use of a piston which, influenced by the aforementioned user command, moves the fluid inside a closed hydraulic circuit to impart a pressure such as to activate the aforementioned brake or the aforementioned clutch.

Following the hydraulic actuation, it is also possible to provide a consequent electric actuation to define an electric signal or the activation of an electric command. When the brake is activated, for example, it is necessary to make a signal that guarantees the following vehicle to adjust the speed accordingly, signaling that is carried out by turning on the stop light.

Some motorcycles have a suitable button panel arranged in correspondence with the actuator device and operated by it for electrical signaling or the activation of an electrical control. In particular, Harley-Davidson® motorcycles have, at least in some models, a push-button panel arranged on the handlebar in correspondence with the front brake actuator device and operated by the same lever adapted to operate the piston of the actuator device.

The replacement of actuator devices for the hydraulic brake/clutch actuation system of first equipment with customized actuator devices must therefore take into account the presence of the push-button panel and its activation.

Some solutions of the known type therefore provide for the modification of the push-button panel at the same time as the modification of the actuator device occurs, in such a way as to adapt the new positioning or the new conformation to the technical needs of electric actuation. However, these solutions have the need to operate on the electrical system of the motorcycle, for example on the CANBUS system, with the consequent complexity and increase in cost, both in the realization of the actuator device and in the relative installation on the motorcycle. Furthermore, modifications to the motorcycle's electrical system can cause problems that could compromise its safety.

An alternative solution of the known type is described in the Italian Patent Application No. IT 102017000001855 and consists of a brake or clutch pump comprising a lever operatively connected to the body of the brake pump and to the operating lever and provided with a lever for the actuation of the push button panel. This solution, while being cheaper and less invasive than the above described known solution, by allowing to keep the original motorcycle push-button panel, has the disadvantage of requiring a linkage to be specifically made according to the size of the lever and the position of the brake pump. Furthermore, the presence of the linkage determines an increase in the number of components that make up the actuator device, with a consequent increase in cost and risk of malfunctions and high maintenance.

Further alternative solutions of the known type are described respectively in the Japanese Patent No. JP S5835229A and in the Great Britain Patent No. GB 2432199A, which have a high level of complexity.

It would therefore be desirable to have an actuator device for the hydraulic brake/clutch actuation system of a motorcycle capable of minimizing the above described drawbacks. In particular, it would be desirable to have an actuator device for the hydraulic brake/clutch actuation system of a motorcycle capable of operating the electric push-button panel of a motorcycle, while preserving the reliability characteristics of the actuator device itself. Furthermore, it would be desirable to have an actuator device for the hydraulic brake/clutch actuation system of a motorcycle capable of guaranteeing the aforementioned characteristics while having a reduced size and cost.

### BRIEF DESCRIPTION OF THE INVENTION

The object of the present invention is to provide an actuator device for the hydraulic brake/clutch actuation system of a motorcycle capable of minimizing the aforementioned problems.

In particular, the object of the present invention is to provide an actuator device for the hydraulic system for actuating the brake/clutch of a motorcycle which guarantees both the simple activation of the electric push-button panel of a motorcycle without any intervention on the electrical system itself and, at the same time, a simple installation.

The object of the present invention is achieved by an actuator device for the hydraulic brake/clutch actuation system of a motorcycle according to the attached claims.

The actuator device for a hydraulic brake/clutch actuation system of a motorcycle, comprises:
a primary support structure able to be operatively coupled to the handlebar of the motorcycle and provided with at least a primary chamber;
a primary piston arranged within the primary support structure and able to be moved within the primary chamber between a primary resting position and a primary working position, and vice versa;
a primary actuating pin solidly coupled to the primary piston and arranged outside the primary support structure for actuating the primary piston between the primary resting position and the primary working position, wherein the free end of the primary actuating pin is arranged at the primary support structure when the primary piston is in the primary working position and is distanced from the primary support structure when the primary piston is in the primary resting position;
a primary elastic element arranged within the primary support structure and able to maintain the primary piston in the primary resting position when not actuated;
a secondary support structure provided with at least a secondary chamber;
a secondary piston arranged within the secondary support structure and able to be moved within the secondary chamber between a secondary resting position and a secondary working position, and vice versa; a secondary actuating pin solidly coupled to the secondary piston and arranged outside the secondary support structure, wherein the free end of the secondary actuating pin is distanced from the secondary support structure when the secondary piston is in the secondary working position and is arranged at the secondary support structure when the secondary piston is in the secondary resting position;
a secondary elastic element arranged within the secondary support structure and able to maintain the secondary piston in the secondary working position when not actuated;
   wherein the primary chamber and the secondary chamber are arranged in fluid communication so that the secondary piston is arranged from the secondary working position to the secondary resting position by the movement of a hydraulic fluid when the primary piston is actuated from the primary resting position to the primary working position, and
   wherein the secondary elastic element is arranged within the secondary chamber.

In this way, when the primary piston is activated for the actuation of the brake or clutch, the secondary piston is consequently moved by the hydraulic fluid to release the button of the electric control panel and allow the stop light to be activated.

In a further embodiment, the secondary support structure is solidly coupled to the primary support structure.

Alternatively, the secondary support structure is separated from the primary support structure.

In this way, it is possible to realize the actuator device both by reducing the overall sizes and by positioning the components of the actuator device according to the desired layout for the motorcycle.

In a further embodiment, the primary chamber and the secondary chamber are arranged in fluid communication by a connection duct interposed between the primary chamber and the secondary chamber.

In this way, it is possible to arrange the two primary and secondary chambers in separate positions, maintaining the connection by means of the connection duct which guarantees the movement of the hydraulic fluid.

In a further embodiment, the connection duct has an end coupled to the primary chamber at said primary working position and the opposite end coupled to the secondary chamber at the secondary resting position.

This arrangement allows the secondary piston to be moved in an opposite manner and in response to the movement of the primary piston from the primary resting position to the primary working position.

In a further embodiment, the primary elastic element is arranged within the primary chamber.

In a further embodiment, the primary elastic element is arranged at the primary working position.

This allows the primary elastic element to arrange the primary piston normally in the primary resting position when not activated.

In a further embodiment, the secondary elastic element is arranged at the secondary resting position.

This allows the secondary elastic element is able to arrange the secondary piston normally in the secondary working position when not activated.

In a further embodiment, the primary elastic element and the secondary elastic element are respectively made by means of a helical spring.

In a further embodiment, the primary support structure comprises a hydraulic fluid container, wherein the hydraulic fluid container is in fluid communication with the primary chamber and with the secondary chamber.

In this way, it is possible to make both the tank portion and the pumping portion in a single body.

In a further embodiment, the actuation device comprises an actuation lever connected to the primary support structure so that to be rotatably about an actuation axis.

The lever allows the user to operate the primary piston, or the primary actuation pin, to provide for the actuation of the brake or clutch and for the simultaneous deactivation of the electric control panel.

### DESCRIPTION OF THE FIGURES

These and further features and advantages of the present invention will become apparent from the disclosure of the preferred embodiment, illustrated by way of a non-limiting example in the accompanying figures, wherein:

FIG. 1 shows a schematic perspective view of a known actuator device, at the electric push button panel of a motorcycle;

FIG. 2 shows a schematic perspective view of the actuator device according to the present invention;

FIG. 3 shows a schematic perspective view of the actuator device of FIG. 2;

FIG. 4 shows a schematic perspective sectional view of the actuator device of FIG. 2;

FIG. 5 shows a schematic perspective sectional view of the actuator device of FIG. 2;

FIG. 6 shows a schematic perspective sectional view of a detail of the actuator device of FIG. 2;

FIG. 7 shows a perspective view of the secondary piston;

FIG. 8 shows a perspective view of the actuator device of FIG. 2, provided with the operating lever.

### DETAILED DESCRIPTION OF THE INVENTION

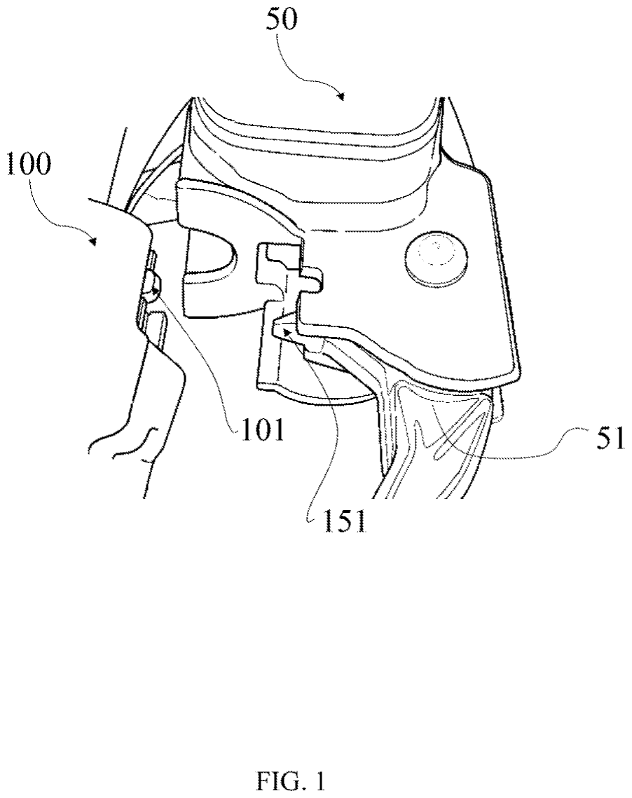

FIG. 1 illustrates an actuator device 50 of the known type, in particular of a Harley-Davidson® brand motorcycle, provided with an actuation lever 51 rotatable connected about an actuation axis.

Lever 51 allows the user to operate the piston (not shown) of the actuator device 50 to actuate the brake. The lever 51 is also provided with a short lever 151 integrated with the lever 51 itself and able to contact the electric push-button panel 100 when the actuator device 50 is mounted on the handlebar of the motorcycle. In particular, the short lever 151 is able to normally contact the button 101 arranged on the electric button panel 100, while the deactivation of the electric button panel 100 is carried out by operating the lever 51 during the simultaneous movement of the short lever 151 which releases the button 101.

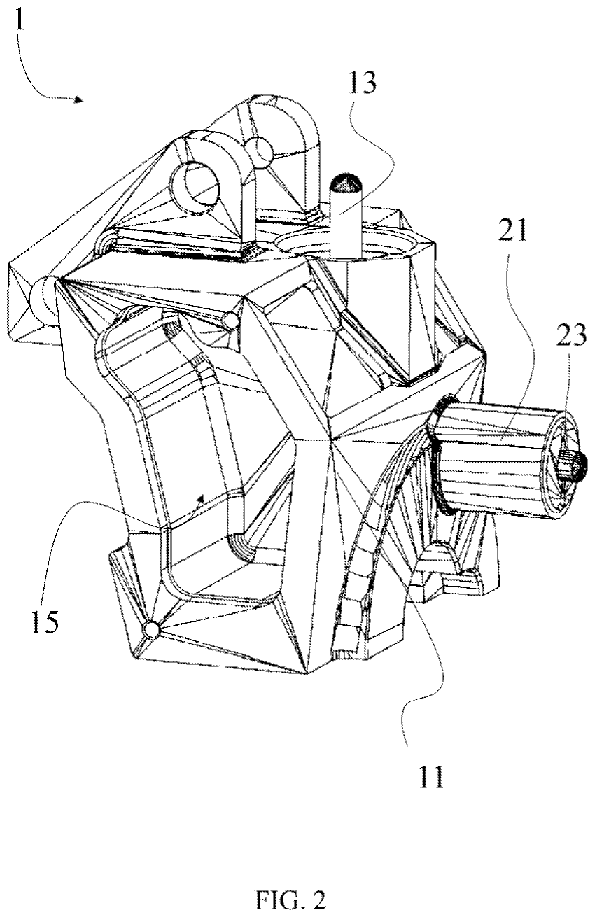

With reference to FIGS. 2-8, the reference number 1 indicates as a whole an actuator device for the hydraulic brake/clutch actuation system of a motorcycle according to the present invention, such as to allow the operation of the same electric push-button panel 100 without the use of elements or leverages part of the actuation lever, as instead illustrated for example in the actuator device 50 of the known type.

The term “primary resting position” means, in the present invention, the position in which the primary piston does not operate the hydraulic system for actuating the brake or clutch of the.

The term “primary working position” means, in the present invention, the position in which the primary piston activates the hydraulic system for actuating the brake or clutch of the motorcycle.

The term “secondary resting position” means, in the present invention, the position in which the secondary piston does not operate the electric push button panel.

The term “secondary working position” means, in the present invention, the position in which the secondary piston activates the electric push button panel.

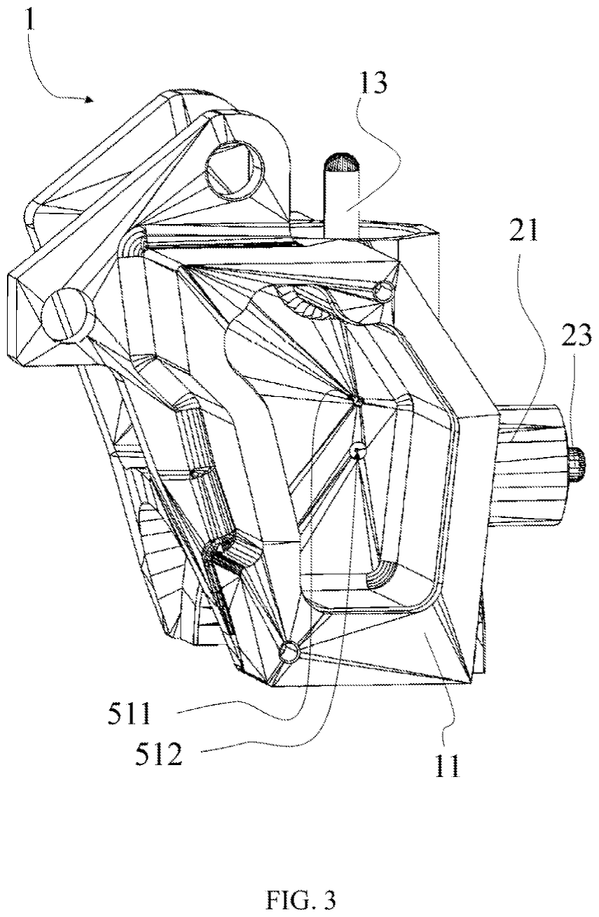

FIGS. 2 and 3 illustrate a schematic perspective view of the actuator device 1 according to the present invention, in which the representations have been made taking into account two different angles for completeness of presentation.

The actuator device 1 for the hydraulic brake/clutch actuation system of a motorcycle illustrated in the aforementioned FIGS. 2 and 3 comprises a primary support structure 11, which in operating conditions is able to be operatively coupled to the motorcycle handlebar (not illustrated). A secondary support structure 21 is integrally coupled to the primary support structure 11.

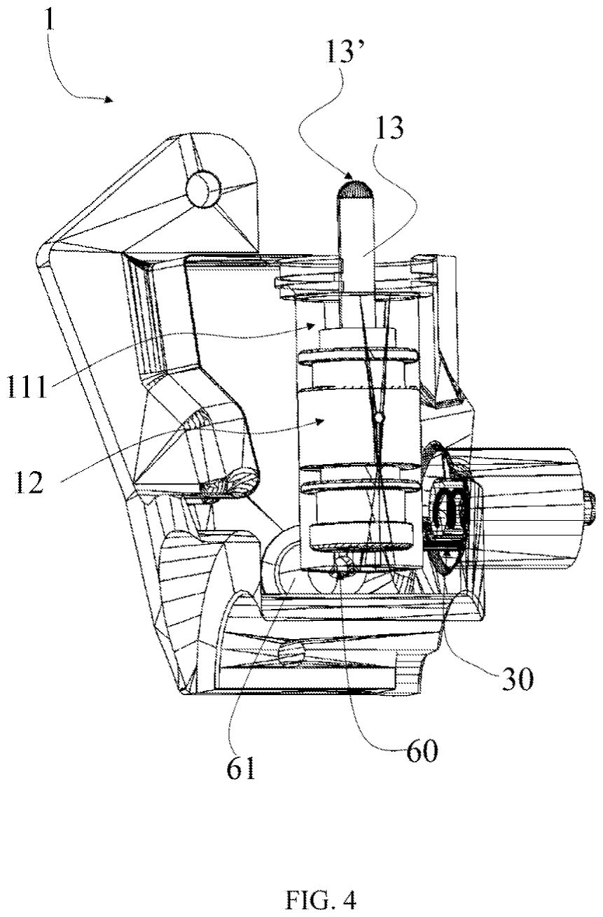

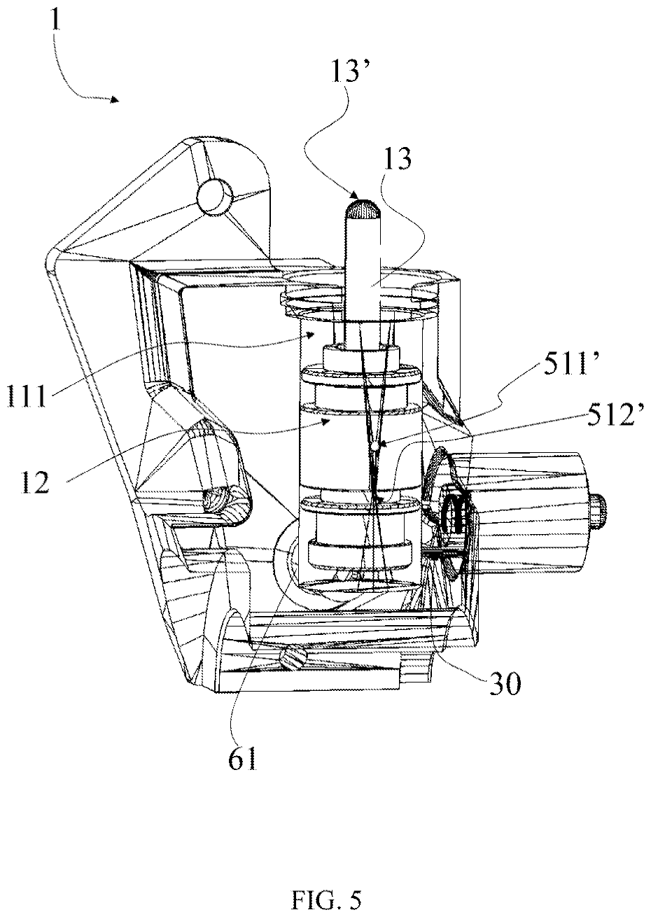

The primary support. structure 11 is defined in such a way as to provide at least one primary chamber 111 for containing the primary piston 12, illustrated in FIGS. 4 and 5 and described in greater detail below. The shape of the primary support structure 11 can be modified according to technical and design needs and in the embodiment herewith illustrated it has a substantially parallelepiped conformation.

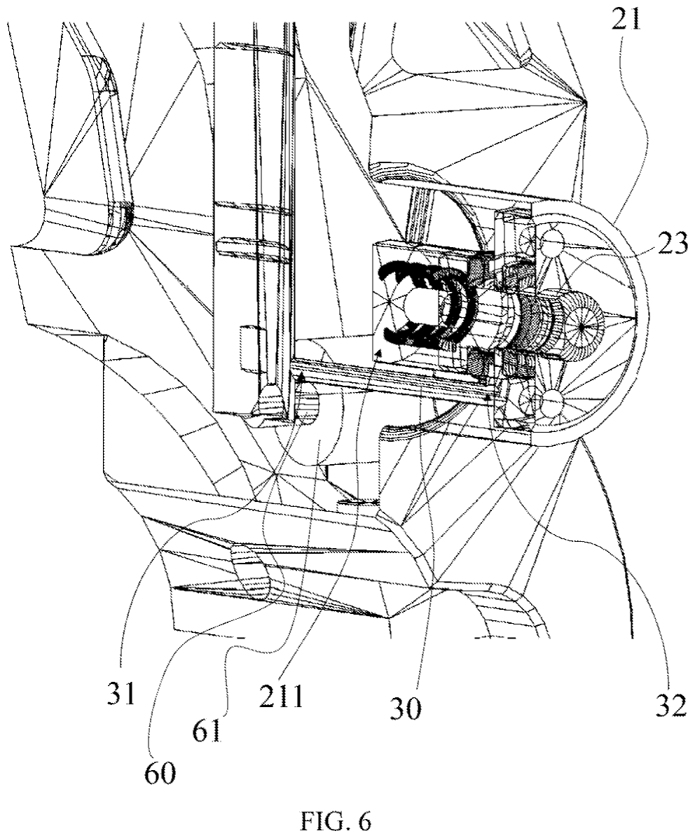

Similarly, the secondary support structure 21 is defined in such a way as to provide at least one secondary chamber 211 for containing the secondary piston 22, illustrated in FIG. 6 and described in greater detail below. The shape of the secondary support structure 21 can be modified according to technical and design needs and in the embodiment herewith illustrated it has a substantially cylindrical conformation.

As illustrated, the primary support structure 11 and the secondary support structure 21 are made of two distinct and integrally coupled parts, but these could equally be made in a single part, for example made by molding, or by two distinct and non-integrally coupled parts, for example in which the secondary support structure is separated from the primary support structure.

In this way, it is possible to realize the actuator device both by reducing the overall sizes, by integrally coupling the support structures, and by positioning the components of the actuator device itself according to the desired layout for the motorcycle, by arranging spaced apart the same support structures in two different positions while in fluid communication.

The mutual arrangement of the primary support structure 11 and of the secondary support structure 21 is also defined, in the present embodiment, by the arrangement of the elements of the primary actuation pin 13 and of the secondary actuation pin 23 as a function of the hypothesized positioning on the motorcycle, but different positions may fall within the inventive scope of the present invention.

FIGS. 4 and 5 illustrate a schematic sectional perspective view of a detail of the actuator device 1 of the present invention, according to two different perspective angles. The sections allow viewing the primary piston 12 arranged within the primary support structure 11 and able to be moved within the primary chamber 111 between a primary resting position and a primary working position, and vice versa.

The actuation of the primary piston 12 is carried out on command of the user by means of a primary actuation pin 13, integrally coupled to the aforementioned primary piston 12.

Although not illustrated, a primary resilient element is disposed within the primary support structure 11 and is able to maintain the primary piston 12 in the primary resting position when not operated. This primary elastic element is preferably made by means of a spring of the helical type.

In particular, the primary elastic element is arranged in the primary chamber 111 and preferably at the primary working position, with reference to the position assumed by the relative primary piston 12. This allows the primary elastic element to arrange the primary piston 12 normally in the primary resting position when not operated.

In the same way, different positions, for example outside the primary chamber 111 or at a different position with reference to the primary piston 12, can be used.

The primary chamber 111, defined by a substantially cylindrical conformation, has an upper opening from which the primary actuation pin 13 protrudes and through which it is free to slide. The latter is therefore arranged outside the primary support structure 11, at least partially and at least in the primary rest position.

As shown in FIGS. 4 and 5, the primary actuation pin 13 is integrally coupled to the primary piston 12 for its actuation between the primary resting position and the primary working position. Taking the aforementioned positions as reference, the free end 13′ of the primary actuation pin 13 is approached to the primary support structure 11 when the primary piston 12 is in the primary working position and is moved away from the primary support structure 11 when the piston 12 primary is in the primary resting position.

FIG. 6 illustrates a schematic sectional view in perspective of a detail of the actuator device 1 of the present invention. The section makes it possible to view the secondary piston 22 arranged within the secondary support structure 21 and able to be moved within the secondary chamber 211 between a secondary resting position and a secondary working position, and vice versa.

The actuation of the secondary piston 22 is achieved by means of the hydraulic fluid following the movement of the primary piston 12 from the primary resting position to the primary working position, as described below in greater detail.

A secondary actuation pin 23 is integrally coupled to the secondary piston 22 and, at the same time, a secondary elastic element 24 is able to keep the secondary piston 22 normally in the secondary working position when not actuated.

The secondary chamber 211, defined by a substantially cylindrical conformation, has a lateral opening from which the secondary actuation pin 23 protrudes and through which it is free to slide. The latter is therefore arranged outside the secondary support structure 21, at least partially and at least in the secondary working position.

As shown in FIG. 6, the secondary actuation pin 23 is integrally coupled to the secondary piston 22 and is actuated by the latter between the secondary working position and the secondary resting position. Taking the aforementioned positions as reference, the free end 23′ of the secondary actuation pin 23 is moved away from the secondary support structure 21 when the secondary piston 22 is in the secondary working position and is approached to the secondary support structure 21 when the piston 22 is in the secondary resting position.

The secondary elastic element 24 is therefore arranged within the secondary support structure 21 and, in the embodiment illustrated therein, within the secondary chamber 211. This secondary elastic element 24 is preferably made by means of a spring of the helical type.

In the same way, different positions, for example outside the primary chamber 111 or at a different position with reference to the primary piston 12, can be used.

The secondary elastic element 24 is arranged at the secondary resting position, with reference to the position assumed. by the secondary piston 22. This allows the secondary elastic element 24 to arrange the secondary piston 22 normally in the secondary working position when not actuated.

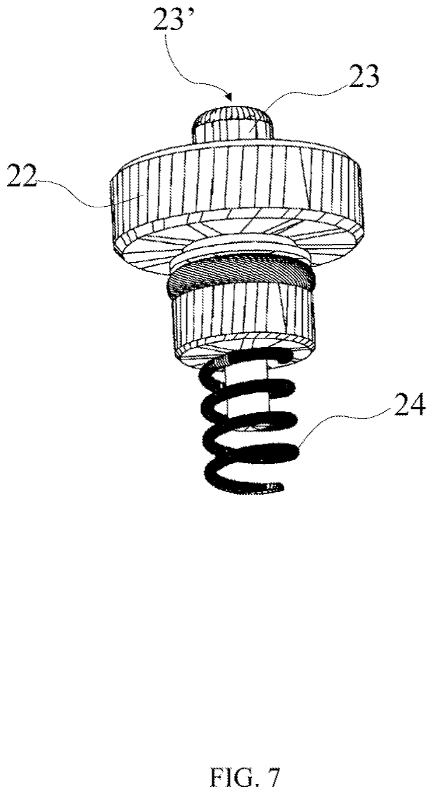

The part of the secondary piston 22, provided with the relative secondary elastic element 24 and the secondary actuation pin 23, is illustrated in greater detail in FIG. 7.

The primary chamber 111 and the secondary chamber 211 are arranged in fluid communication so that upon actuation of the primary piston 12 from the primary resting position to the primary working position the secondary piston 22 is arranged from the secondary working position to the secondary resting position by moving a hydraulic fluid.

In particular, the primary chamber 111 and the secondary chamber 211 are arranged in fluid communication by means of a connection duct 30 interposed between the primary chamber 111 and the secondary chamber 211, as illustrated in the attached FIGS. 4-6.

In this way, it is possible to arrange the two primary 111 and secondary 211 chambers in separate positions, maintaining the connection by means of the aforementioned connection duct 30 which guarantees the movement of the hydraulic fluid.

In the embodiment herewith illustrated and described, the connection duct 30 has an end 31 coupled to the primary chamber 111 at the primary working position and the opposite end 32 coupled to the secondary chamber 211 at the secondary resting position. This arrangement allows the secondary piston 22 to be moved in an opposite manner and in response to the movement of the primary piston 12 from the primary resting position to the primary working position. Although not defined for the aforementioned primary 111 and secondary 211 chambers, the relative working and resting positions refer to the position respectively of the primary piston 12 and of the secondary piston 22 when in said positions.

Different arrangements and sizing for the components described can also be used, while falling within the inventive concept according to the present invention.

The main chamber 111 also has a further fluid connection with the hydraulic brake/clutch actuation system of a motorcycle (not shown). This fluid connection is achieved by means of the actuation duct 60 arranged downstream of the end 31. coupled to the connection duct 30.

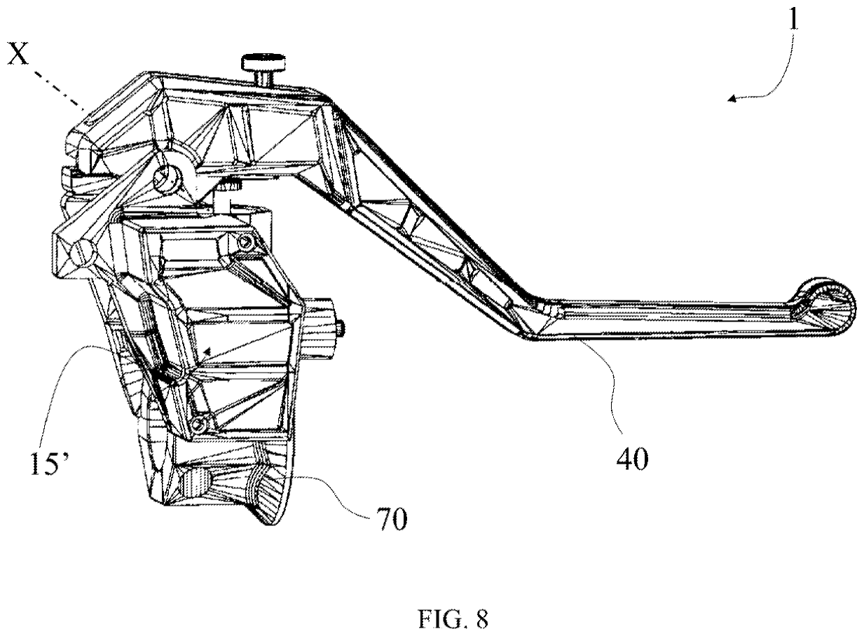

According to the embodiment herewith described, the primary support structure 11 further comprises a container 15 for the hydraulic fluid, as illustrated in FIG. 2, although without a hermetic cover of the container 15 for the hydraulic fluid itself. An example of coverage 15′ can, however, be displayed in FIG. 8.

The container 15 for the hydraulic fluid results in fluid communication with the primary chamber 111 and, indirectly, with the secondary chamber 211. In this way, it is possible to define both the tank portion and the pumping portion with a single body.

In particular, the container 15 for the hydraulic fluid is provided with two pouring holes 511, 512, as shown in FIG. 3, which correspond to the same pouring holes 511′, 512′ made in the primary chamber 111. Subsequently, the connection duct 30 ensures the communication of fluid between the primary chamber 111 and the secondary chamber 211, or between the pouring holes 511, 512 of the container 15 for hydraulic fluid and the secondary chamber 211.

According to different embodiments (not shown), the container for the hydraulic fluid could be separated from the primary and secondary support structure and it could result in fluid connection with the primary chamber via a further communication duct.

Finally, FIG. 8 illustrates a perspective view of the actuator device 1 of FIG. 2, provided with the operating lever 40. The latter is connected to the primary support structure 11 in a rotatable way around an X axis of actuation, visible in the same FIG. 8.

ln the same FIG. 8 is also shown a device 70 for coupling to the motorcycle handlebar, capable of allowing the installation of the actuator device 1 by placing the secondary actuation pin 23 in contact with the button of the electric control panel.

Lever 40 allows the user to operate the primary piston 12, or the primary actuation pin 13, to provide for the actuation of the brake or clutch and the simultaneous deactivation of the electric push-button panel. The actuator device 1 of the present invention defines a closed hydraulic circuit in the hydraulic brake/clutch actuation system of a motorcycle. Therefore, when the lever 40 is activated, the primary piston 12 for the actuation of the brake or clutch is induced to move through the aforementioned primary actuation pin 13, from the primary resting position to the primary working position. Consequently, the secondary piston 22 is moved by the hydraulic fluid from the secondary working position to the secondary resting position, the hydraulic fluid being forced from the end 31 of the connection duct 30, at the primary chamber 111, to the opposite end 32 of the same connection duct 30 for connection, at the secondary chamber 211, to release the button of the electric push-button panel and allowing the stop light to be activated.

When the user releases the lever 40, the primary piston 12 is repositioned from the primary working position to the primary resting position, by means of the thrust imparted by the primary elastic element (not shown), and consequently a repositioning of the piston 22 from the secondary resting position to the secondary working position occurs, by means of the thrust exerted by the secondary elastic element 24.

The actuator device for the hydraulic brake/clutch actuation system of a motorcycle according to the present invention therefore has a simple activation of the electric button panel of a motorcycle without any intervention on the electrical system itself.

it is also possible to make changes and modifications to the original actuator device while maintaining, the original electric pushbutton panels and, therefore, without making any changes to the electrical system of the motorcycle.

This also allows to obtain at the same time an actuator device for the hydraulic brake/clutch actuation system of a motorcycle that is simple and economical to install.

1. An actuator device (1) for a hydraulic brake/clutch actuation system of a motorcycle, comprising:
a primary support structure (11) able to be operatively coupled to the handlebar of said motorcycle and provided with at least a primary chamber (111);
a primary piston (12) arranged within said primary support structure (11) and able to be moved within said primary chamber (111) between a primary resting position and a primary working position, and vice versa;
a primary actuating pin (13) solidly coupled to said primary piston (12) and arranged outside said primary support structure (11) for actuating said primary piston (12) between said primary resting position and said primary working position, wherein the free end (131) of said primary actuating pin (13) is arranged at said primary support structure (11) when said primary piston (12) is in said primary working position and is distanced from said primary support structure (11) when said primary piston (12) is in said primary resting position;
a primary elastic element arranged within said primary support structure (11) and able to maintain said primary piston (12) in said primary resting position when not actuated;
a secondary support structure (21) provided with at least a secondary chamber (211);
a secondary piston (22) arranged within said secondary support structure (21) and able to be moved within said secondary chamber (211) between a secondary resting position and a secondary working position, and vice versa;
a secondary actuating pin (23) solidly coupled to said secondary piston (22) and arranged outside said secondary support structure (21), wherein the free end (231) of said secondary actuating pin is distanced from said secondary support structure (21) when said secondary piston (22) is in said secondary working position and is arranged at said secondary support structure (21) when said secondary piston (22) is in said secondary resting position;
a secondary elastic element (24) arranged within said secondary support structure (21) and able to maintain said secondary piston (22) in said secondary working position when not actuated;
wherein said primary chamber (111) and said secondary chamber (211) are arranged in fluid communication so that said secondary piston (22) is arranged from said secondary working position to said secondary resting position by the movement of a hydraulic fluid when said primary piston (12) is actuated from said primary resting position to said primary working position, and wherein said secondary elastic element (24) is arranged within said secondary chamber (211).

2. The actuator device (1) for a hydraulic brake/clutch actuation system of a motorcycle according to claim 1, wherein said secondary support structure (21) is solidly coupled to said primary support structure (11).

3. The actuator device (1) for a hydraulic brake/clutch actuation system of a motorcycle according to claim 1, wherein said secondary support structure (21) is separated from said primary support structure (11).

4. The actuator device (1) for a hydraulic brake/clutch actuation system of a motorcycle according to claim 1, wherein said primary chamber (111) and said secondary chamber (211) are arranged in fluid communication by a connection duct (30) interposed between said primary chamber (111) and said secondary chamber (211).

5. The actuator device (1) for a hydraulic brake/clutch actuation system of a motorcycle according to claim 4, wherein said connection duct (30) has an end (31) coupled to said primary chamber (111) at said primary working position and the opposite end (32) coupled to said secondary chamber (211) at said secondary resting position.

6. The actuator device (1) for a hydraulic brake/clutch actuation system of a motorcycle according to claim 1, wherein said primary elastic element is arranged within said primary chamber (111).

7. The actuator device (1) for a hydraulic brake/clutch actuation system of a motorcycle according claim 6, wherein said primary elastic element is arranged at said primary working position.

8. The actuator device (1) for a hydraulic brake/clutch actuation system of a motorcycle according to claim 1, wherein said secondary elastic element (24) is arranged at said secondary resting position.

9. The actuator device (1) for a hydraulic brake/clutch actuation system of a motorcycle according to claim 1, wherein said primary elastic element and said secondary elastic element (24) are respectively made by means of a helical spring.

10. The actuator device (1) for a hydraulic brake/clutch actuation system of a motorcycle according to claim 1, wherein said primary support structure (11) comprises a hydraulic fluid container (15), wherein said hydraulic fluid container (15) is in fluid communication with said primary chamber (111) and with said secondary chamber (211).

11. The actuator device (1) for a hydraulic brake/clutch actuation system of a motorcycle according to claim 1, comprising an actuation lever (40) connected to said primary support structure (11) so that to ne rotatably about an actuation axis (X).
